(19) United States
(12) Patent Application Publication
(10) Pub. No.: US 2015/0312023 A1
(43) Pub. Date: Oct. 29, 2015

(54) Time Signal Propagation Delay Correction

(71) Applicant: Schweitzer Engineering Laboratories, Inc., Pullman, WA (US)

(72) Inventors: Raymond W. Rice, Pullman, WA (US); Srinivas Achanta, Pullman, WA (US)

(73) Assignee: Schweitzer Engineering Laboratories, Inc., Pullman, WA (US)

(21) Appl. No.: 14/264,394

(22) Filed: Apr. 29, 2014

(51) Int. Cl. H04L 7/00

(52) U.S. Cl. CPC H04L 7/0041

(57) ABSTRACT

Disclosed herein are a variety of systems and methods for correcting for propagation delay in time signals used in connection with an electric power generation and delivery system. According to various embodiments, a device consistent with the present disclosure may determine an estimated propagation delay between an accurate time source and a receiving device. The propagation delay may be determined based on a variety of transmission parameters including, for example, communication channel type and/or length. A corrected time signal may be generated by advancing a reference incitation such as an “on-time” reference and/or “start-of-second” reference included in the time signal by an amount associated with the propagation delay. The corrected time signal may then be transmitted to the receiving device.

### TECHNICAL FIELD

This disclosure relates to systems and methods for correcting propagation delay in time signals and, more particularly, to systems and methods for correcting for propagation delay in inter-range instrumentation group time signals used in connection with control of an electric power delivery system.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a simplified timing diagram of time signals consistent with embodiments disclosed herein.

FIG. 2 illustrates a diagram showing propagation delay of a time signal and propagation delay correction consistent with embodiments disclosed herein.

FIG. 3 illustrates a timing diagram showing propagation delay correction of a time signal consistent with embodiments disclosed herein.

FIG. 4 illustrates a flow chart of a method for correcting for propagation delay of a time signal consistent with embodiments disclosed herein.

FIG. 5 illustrates a simplified diagram of one embodiment of an electric power delivery system that includes intelligent electronic devices consistent with embodiments disclosed herein.

FIG. 6 illustrates a functional block diagram of an intelligent electronic device consistent with embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Electrical power generation and delivery systems are designed to generate, transmit, and distribute electrical energy to loads. Electrical power generation and delivery systems may include a variety of equipment, such as electrical generators, electrical motors, power transformers, power transmission and distribution lines, circuit breakers, switches, buses, transmission and/or feeder lines, voltage regulators, capacitor banks, and the like. Such equipment may be monitored, controlled, automated, and/or protected using intelligent electronic devices (IEDs) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (PLCs), programmable automation controllers, input and output modules, governors, exciters, statcom controllers, SVC controllers, OLTC controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

Various actions performed by IEDs included in an electric power generation and delivery system may be coordinated using time-coordinated instructions and/or other time-coordinated information exchanged therebetween. For example, one or more IEDs may be configured to detect and protect electrical power system equipment from abnormal conditions, such as fault events, by issuing one or more time-coordinated control instructions to associated electrical power system equipment configured to mitigate damage caused by the abnormal conditions. One or more IEDs may further be configured to generate, distribute, and/or receive monitored system data in the form of time-synchronized measurement data relating to monitored currents and/or voltages (e.g., represented as time-synchronized phasors or the like) for use in connection with associated monitoring, control, automation, and/or protection activities.

In certain embodiments, common time signals, which in certain instances may be referred to herein as time signals, may be utilized for synchronizing various data exchanged between IEDs and/or associated electrical power system equipment (e.g., by applying time stamps or the like). Common time signals may provide an indication of an accurate and/or standardized time such as, for example, coordinated universal time (UTC) or Greenwich Mean Time (GMT), although other time standards may also be utilized in connection with the disclosed systems and methods. Common time signals may be provided to various IEDs by a centralized accurate time source such as, for example, an atomic clock and/or the like. In further embodiments, common time signals may be provided to various IEDs by one or more synchronized distributed accurate time sources.

Common time signals may be distributed to various IEDs in a variety of ways, including via wired and/or wireless communication channels. For example, common time signals may be distributed to various IEDs via an IRIG signal, a Global Navigation Satellite System (GNSS) communication signal, a common radio signal such as WWV or WWVB, a network time signal such as IEEE 1588, or the like. In certain embodiments, common time signals may be distributed to various IEDs using a variety of different types of communication channels. For example, an IED associated distribution substation location of an electric power delivery system may wirelessly receive a common time signal and distribute the time signal to one or more other IEDs associated with the distribution station via one or more wired connections.

A common time signal may experience a certain amount of propagation delay during transmission. For example, propagation delay may occur during transmission of a common time signal from a centralized accurate time source to a remotely-located IED receiving the common time signal for use in connection with time-synchronized communications and/or activities. Propagation delay may be related to a variety of transmission parameters including, for example, transmission cable length, transmission cable type, ambient temperature, and/or the like. As a common time signal may be used as a reference indication of an accurate universal time for purposes of coordinating various communications and/or activities, propagation delay impacting a common time signal may detrimentally affect the accuracy of the signal for use as a reference.

To compensate for propagation delay time information included in the common time signal may be advanced by a propagation delay correcting device by a period associated with the delay in some embodiments. For example, a propagation delay correcting device may receive a common time signal. A period of time associated with propagation delay between an accurate time source and a receiving IED may be estimated (e.g., a number of minutes and/or seconds of an associated propagation delay period). Encoded time information included in the common time signal may be decoded and modified to advance the corresponding time information by the estimated propagation delay period by modifying the encoded time information. A corrected time signal may be generated that includes the modified encoded time information and be transmitted to an associated receiving IED. The receiving IED may receive the corrected time signal, and may utilize the modified encoded time information included in the corrected time signal in connection with coordinating various time-synchronized communications and/or activities.

While the above method may correct for propagation delay, accurately estimating a period of time associated with propagation delay between an accurate time source and a receiving IED and adjusting may be difficult. For example, certain locations may follow daylight savings time (DST) whereas others many not. Accordingly, to generate an accurate corrected time signal, various embodiments consistent with the present disclosure may provide information regarding a location of a propagation delay correcting device relative to an accurate time source and/or a receiving IED as well as a time zone associated with the location. The above method may further take into account corrections to the time signal for leap year and/or leap second events.

Systems and methods disclosed herein may facilitate propagation delay correction in a manner that ameliorates at least some of the difficulties described above. In certain embodiments, a common time signal associated with an accurate time source (e.g., a UTC reference time source or the like) may include one or more reference indications denoting a start of a data frame containing encoded time information (e.g., day, hour, minutes, seconds, etc.). A receiving IED may associate a time that the reference indication is received with the encoded time information in the data frame following the indication. That is, the time that the reference indication is received by an IED may be associated with the encoded day, hour, minute, and/or second information included in the data frame following the reference indication. In this manner, reference indications included in a common time signal may be utilized to coordinate various time-synchronized actions and/or communications.

Consistent with embodiments disclosed herein, a propagation delay correcting device may generate a corrected time signal by estimating a propagation delay between an accurate time source and one or more receiving IEDs. A variety of information may be utilized in connection with estimating the propagation delay including, without limitation, transmission cable length, transmission cable type, ambient temperature, and/or the like. In certain embodiments, an estimated propagation delay may be determined and/or otherwise calculated by a propagation delay correcting device. In further embodiments, the estimated propagation delay may be provided to the propagation delay correcting device by a user thereof.

The propagation delay correcting device may generate a corrected time signal by advancing one or more reference indications included in a common time signal by a period associated with the estimated propagation delay. For example, in a common time signal where a reference indication is associated with a rising signal edge, the rising signal edge of the reference indication may be advanced by a period associated with the estimated propagation delay in connection with generating a corrected time signal. Accordingly, following transmission to a receiving IED, the rising signal edge of the reference indication will be received by the IED at an accurate time.

In certain embodiments, in connection with generating a corrected time signal, signal edges of one or more reference indications as well as encoded time information following the reference indications may be advanced by a period associated with an estimated propagation delay. In other embodiments, however, only reference indications may be advanced by the period associated with the estimated propagation delay, as any encoded time information following the corrected reference indication will be associated with a time the reference indication is received by a receiving IED. Accordingly, if a receiving device can effectively decode the encoded time information without propagation delay correction, the uncorrected decoded time information will be associated with the corrected reference indication. In certain embodiments, only advancing signal edges associated with reference indications may offer certain efficiencies in connection with propagation delay correction.

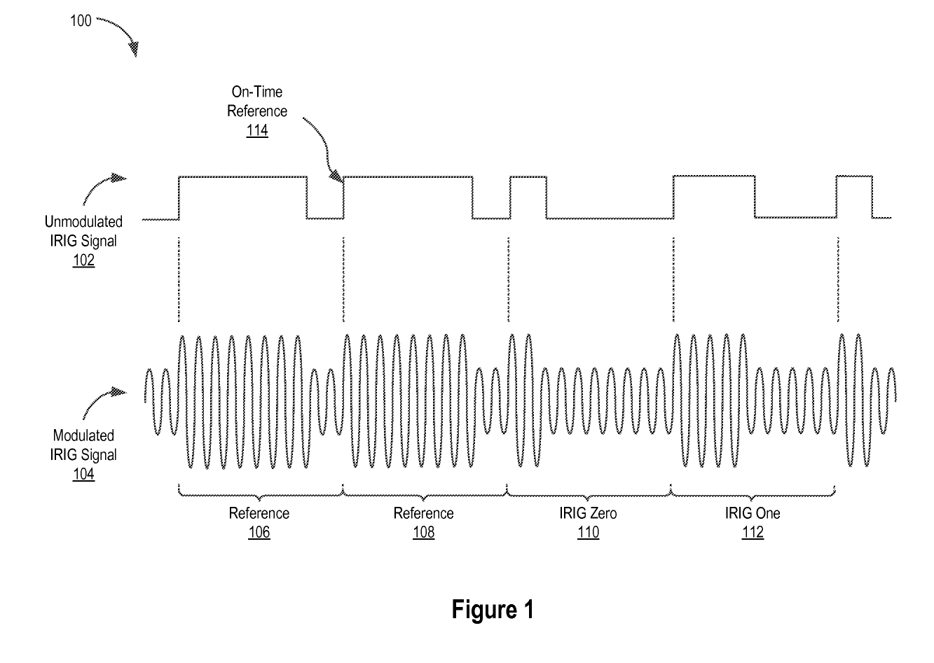

Certain embodiments disclosed herein may be utilized in connection with common time signals encoded using the inter-range instrumentation group (IRIG) time-code standard (e.g., the IRIG-B standard or the like). FIG. 1 illustrates a simplified timing diagram 100 of time signals 102, 104 implementing the IRIG time-code standard consistent with embodiments disclosed herein. Particularly, the simplified timing diagram 100 illustrates time signals 102, 104 implementing the IRIG-B standard. Although embodiments disclosed herein are discussed in connection with the IRIG-B standard, it will be appreciated that a variety of other time standards may also be utilized in connection with the disclosed embodiments.

Signals encoded using the IRIG-B time standard may have a time frame of 1 second—that is, one data frame of encoded time information is transmitted every second. IRIG-B encoded signals may transmit 100 pulses-per-second with an index count of 10 milliseconds over the 1 second time frame. Time information may be encoded in the signal using binary-coded decimal (BCD) and/or straight binary seconds (SBS) formats, and may include information indicative of a day of the year (i.e., 1-366), hours, minutes, and/or seconds.

IRIG time formats may use pulse-width coding and include one or more reference indications 106, 108 preceding encoded time information 110, 112 in a data frame. In some embodiments, the one or more reference indications 106, 108 may have a duration of 80% of an index count interval. A binary “0” 110 may have a duration of 20% of an index count interval and a binary “1” 112 may have a duration of 50% of an index count interval. In some embodiments, the unmodulated IRIG-B signal 102 may be transmitted to receiving devices as an unmodulated pulse-width coded DC level shift signal. In other embodiments, the sine wave carrier modulated IRIG-B signal 104 may be transmitted to receiving devices. In some embodiments, the sine wave carrier may have a frequency of 1 kHz.

As illustrated, an IRIG-B encoded time signal may include two reference indications 106, 108. In certain instances, the presence of two consecutive reference indications 106, 108 marks the start of a time frame. The first reference indication 106 may be utilized as an indication that subsequent a signal edge 114 (e.g., a rising signal edge) associated with a second reference indication 108 marks a time associated with the encoded time information of the data frame. In some embodiments, the signal edge 114 may be referred to as an “on-time” and/or a “start-of-second” indication associated with a particular time indicated by the subsequent encoded time information.

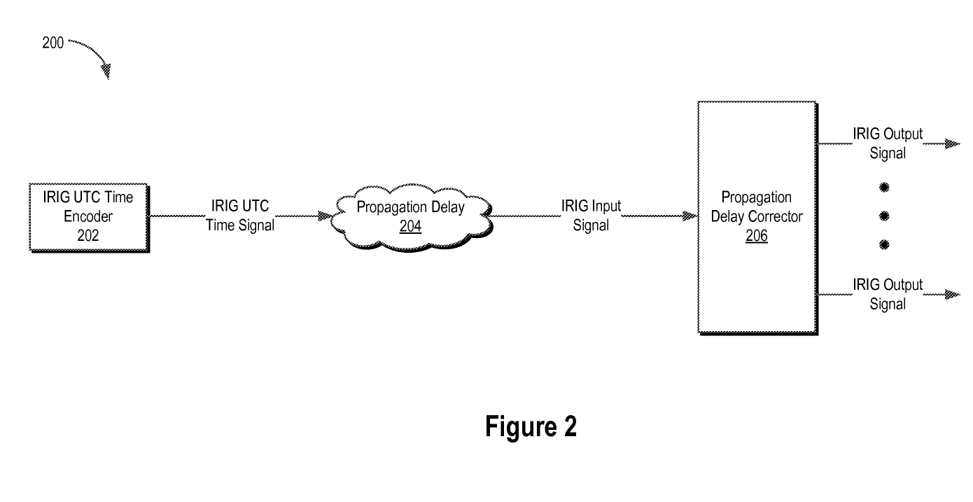

FIG. 2 illustrates a diagram 200 showing propagation delay of a time signal and propagation delay correction consistent with embodiments disclosed herein. As illustrated, an accurate time source (e.g., a UTC time) may be encoded by an IRIG time encoder 202 to generate an IRIG encoded time signal for distribution to one or more receiving devices. During transmission to the receiving devices, however, the IRIG encoded time signal may experience certain propagation delay 204. As discussed above, propagation delay 204 may be related to a variety of transmission parameters including, for example, transmission cable length, transmission cable type, ambient temperature, and/or the like.

The IRIG encoded time signal may be corrected by a propagation delay correcting device 206 to correct for propagation delay 204. The propagation delay correcting device 206 may estimate a delay period associated with the propagation delay 204 based on available transmission parameters impacting propagation delay of the IRIG encoded time signal. The propagation delay corrector 206 may generate one or more corrected IRIG time signals by advancing one or more reference indications included in the IRIG UTC time signal by a period associated with the estimated propagation delay. For example, in an IRIG time signal where an on-time reference is associated with a rising signal edge of a second reference indication in a frame, the rising signal edge of the on-time reference may be advanced by the estimated propagation delay in a corrected IRIG time signal.

In certain embodiments, the propagation delay correcting device 206 may be associated with a single receiving device and, accordingly, may generate a single corrected IRIG time signal. In further embodiments, the propagation delay correcting device 206 may be associated with a plurality of receiving devices and may be configured to generate a plurality of corrected IRIG time signals based on the IRIG encoded time signal received by the propagation delay correcting device 206. In some embodiments, the plurality of corrected IRIG time signals generated may include corrections for a plurality of different propagation delays associated with various receiving devices. For example, an IRIG signal may experience a first amount of propagation delay during transmission to a first device and a second amount of propagation delay during transmission to a second device. To correct for the various delays, the propagation delay correcting device 206 may generate a first corrected IRIG time signal for transmission to the first device correcting for the first amount of propagation delay and a second corrected IRIG time signal for transmission to the second device correcting for the second amount of propagation delay.

In some embodiments, the propagation delay correcting device 206 may be proximately located to one or more receiving devices and be configured to correct for propagation delay 204 occurring before receipt of an associated IRIG time signal by the propagation delay correcting device 206. In further embodiments, the propagation delay correcting device 206 may correct for anticipated propagation delay 204 between the propagation delay correcting device 206 and/or an accurate time source and a receiving device. Accordingly, the propagation delay correcting device 206 may correct for estimated propagation delay 204 of an IRIG time signal before the signal has actually experienced such delay.

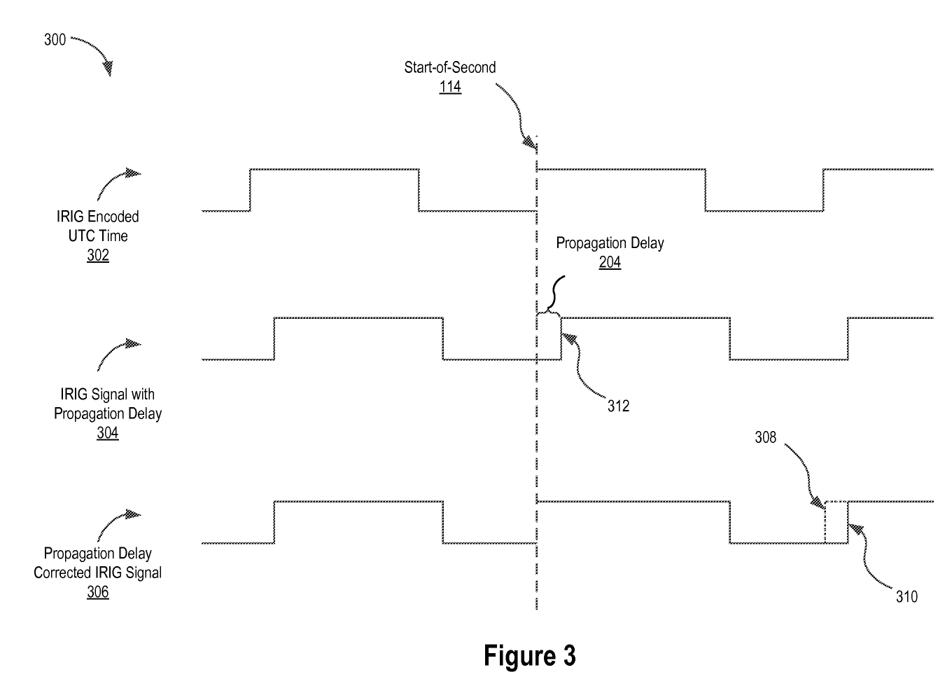

FIG. 3 illustrates a timing diagram 300 showing propagation delay correction of a time signal consistent with embodiments disclosed herein. Particularly, the illustrated timing diagram 300 shows an exemplary IRIG encoded accurate common time signal 302 (e.g., generated by an accurate time source), a corresponding IRIG encoded time signal after experiencing propagation delay 304, and a IRIG encoded time signal corrected for the propagation delay consistent with embodiments disclosed herein.

Propagation delay may cause signal edges of an IRIG encoded signal 304 (e.g., signal edge 312) to be delayed by an amount of time 204 associated with the propagation delay. For example, signal edge 312, indicating an on-time reference of the IRIG signal experiencing propagation delay 304, may be received by a receiving IED following a period of time 204 after the actual on-time reference 114. To correct for this delay, a propagation delay corrected IRIG signal 306 may be generated that advances the signal edge 312 by the period of time 204 associated with the propagation delay such that the signal edge 312 occurs at the same time and/or substantially at the same time as the actual on-time reference 114. As discussed above, in certain embodiments, the period 204 associated with propagation delay may be determined and/or otherwise calculated by a propagation delay correcting device based on a variety of available transmission parameters (e.g., using a lookup table or the like). In further embodiments, the period 204 associated with propagation delay 204 may be provided to the propagation delay correcting device by a user.

As the corrected on-time reference signal edge of the propagation delay corrected IRIG signal 306 is aligned and/or substantially aligned with the actual on-time reference 114, timing information following the on-time reference signal edge of the propagation delay corrected IRIG signal 306 will be associated with the actual on-time reference 114 by a receiving IED. In certain embodiments, signal edges associated with encoded timing information in a data frame following an on-time reference 114 may also be advanced by an amount corresponding to the propagation delay (e.g., period 204). For example, in the illustrated timing diagram 300, signal edge 310 of the propagation delay corrected IRIG signal 306 may be advanced to 308. In other embodiments, however, only on-time reference signal edges (e.g., edge 312) may be corrected for propagation delay, as any encoded time information following the corrected on-time signal edge will be associated with a time the on-time signal is received by a receiving IED. Accordingly, if a receiving device can effectively decode the encoded time information propagation delay correction, the decoded time information may be associated with the corrected on-time reference signal edge. In certain embodiments, correcting for propagation delay in only on-time reference signal edges may provide certain processing efficiencies.

In some embodiments, propagation delay may be corrected up to a certain threshold amount based on capabilities of a receiving IED. For example, propagation delay may be corrected by advancing an on-time signal edge up to an amount that a receiving IED may properly decode encoded time information following the advanced on-time signal edge that has not been advanced by an amount of the propagation delay.

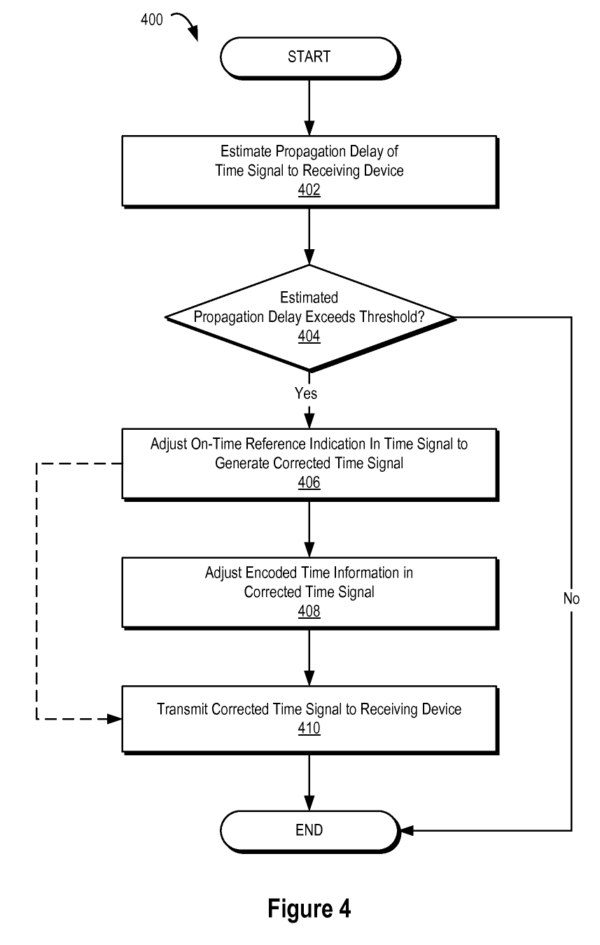

FIG. 4 illustrates a flow chart of a method 400 for correcting for propagation delay of a time signal consistent with embodiments disclosed herein. In certain embodiments, the method 400 may be performed by a propagation delay correcting device configured to receive a time signal from an accurate time source and distribute a propagation-corrected signal to one or more receiving devices. In further embodiments, the method 400 may be performed by an accurate time source prior to transmitting a time signal to one or more receiving devices based on anticipated propagation delay. In yet further embodiments, the method 400 may be performed by one or more modules integrated in a receiving device configured to correct a received time signal for propagation delay prior to using the signal in connection with time-synchronized activities and/or communications.

At 402, an estimated propagation delay of a time signal during transmission between a source and a receiving device may be determined. Propagation delay may be estimated and/or otherwise calculated based on a variety of available transmission parameters including, for example, transmission cable length, transmission cable type, ambient temperature, and/or the like. In certain embodiments, estimated propagation delay may be determined by a propagation delay correcting device based on available transmission parameters (e.g., using a look-up table associating propagation delay with various transmission parameters). In further embodiments, an estimated propagation delay may be provided to a propagation delay correcting device by a user.

At 404, a determination may be made whether the estimated propagation delay is below a threshold level of propagation delay. In certain embodiments, the threshold level of propagation delay may be a level where various time-coordinated activities and/or communications are not substantially and/or detrimentally affected by the propagation delay. For example, a picosecond of delay may not determinately affect time-coordinated activities and/or communications between various IEDs.

If the estimated propagation delay is below the threshold, the method 400 may terminate and a common time signal may be sent to one or more received devices without propagation delay correction. If, however, the propagation delay is above the threshold, the method 400 may proceed to 406. At 406, an on-time indication of the time signal may be advanced by the estimated propagation delay determined at 402 to generate a propagation delay corrected time signal. In certain embodiments, the method 400 may proceed to 410, where the propagation delay corrected time signal may be transmitted to one or more associated receiving IEDs. In further embodiments, the method 400 may proceed from 406 to 408, where signal edges associated with encoded time information of time signal may also be advanced by the estimated propagation delay determined at 402 in connection with generating the propagation delay corrected time signal. Once generated, the propagation delay corrected time signal may be transmitted to one or more associated received IEDs.

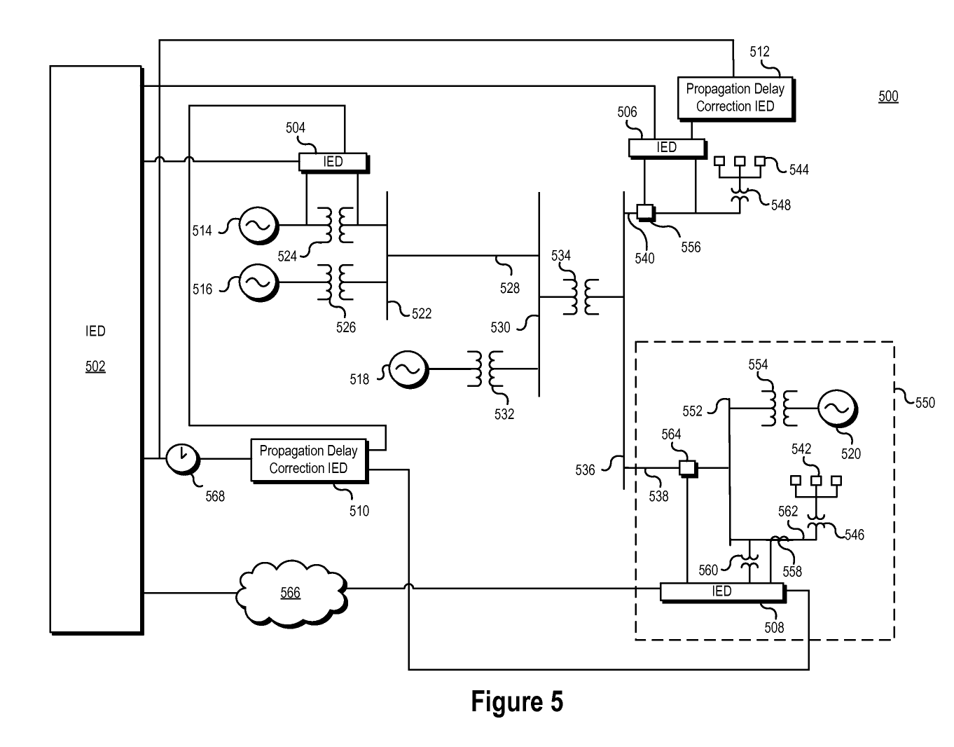

FIG. 5 illustrates a simplified diagram of an electric power generation and delivery system 500 that includes IEDs 502-512 consistent with embodiments disclosed herein. Although illustrated as a one-line diagram for purposes of simplicity, electrical power generation and delivery system 500 may also be configured as a three phase power system. Moreover, embodiments of the disclosed systems and methods may be utilized in connection with any suitable electric power generation and delivery system and is therefore not limited to the specific system 500 illustrated in FIG. 5. Accordingly, embodiments may be utilized in connection with, for example, in industrial plant power generation and delivery systems, distributed generation power generation and delivery systems, and utility electric power generation and delivery systems.

The electric power generation and delivery system 500 may include generation, transmission, distribution, and power consumption equipment. For example, the system 500 may include one or more generators 514-520 that, in some embodiments, may be operated by a utility provider for generation of electrical power for the system 500. Generators 514 and 516 may be coupled to a first transmission bus 522 via step up transformers 524 and 526, which are respectively configured to step up the voltages provided to first transmission bus 522. A transmission line 528 may be coupled between the first transmission bus 522 and a second transmission bus 530. Another generator 518 may be coupled to the second transmission bus 530 via step up transformer 532 which is configured to step up the voltage provided to the second transmission bus 530.

A step down transformer 534 may be coupled between the second transmission bus 530 and a distribution bus 536 configured to step down the voltage provided by the second transmission bus 530 at transmission levels to lower distribution levels at the distribution bus 536. One or more feeders 538, 540 may draw power from the distribution bus 536. The feeders 538, 540 may distribute electric power to one or more loads 542, 544. In some embodiments, the electric power delivered to the loads 542, 544 may be further stepped down from distribution levels to load levels via step down transformers 546 and 548, respectively.

Feeder 538 may feed electric power from the distribution bus 536 to a distribution site 550 (e.g., a refinery, smelter, paper production mill, or the like). Feeder 538 may be coupled to a distribution site bus 552. The distribution site 550 may also include a distributed generator 520 configured to provide power to the distribution site bus 552 at an appropriate level via transformer 554. The distribution site 550 may further include one or more loads 542. In some embodiments, the power provided to the loads 542 from the distribution site bus 552 may be stepped up or stepped down to an appropriate level via transformer 546. In certain embodiments, the distribution site 550 may be capable of providing sufficient power to loads 542 independently by the distributed generator 520, may utilize power from generators 514-518, or my utilize both the distributed generator 520 and one or more of generators 514-518 to provide electric power to the loads.

IEDs 502-508 may be configured to control, monitor, protect, and/or automate the electric power system 500. As used herein, an IED may refer to any microprocessor-based device that monitors, controls, automates, and/or protects monitored equipment within an electric power system and/or is configured to implement any of the systems and methods disclosed herein. In some embodiments, IEDs 502-508 may gather status information from one or more pieces of monitored equipment. Further, IEDs 502-508 may receive information concerning monitored equipment using sensors, transducers, actuators, and the like. Although FIG. 5 illustrates separate IEDs monitoring a signal (e.g., IED 504) and controlling a breaker (e.g., IED 508), these capabilities may be combined into a single IED.

FIG. 5 illustrates various IEDs 502-512 performing various functions for illustrative purposes and does not imply any specific arrangements or functions required of any particular IED. In some embodiments, IEDs 502-508 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. For example, IEDs 502-508 may be configured to monitor and communicate information relating to overcurrent and/or interharmonic conditions of a monitored line (e.g., a feeder and/or transmission line). Further, IEDs 502-508 may be configured to communicate calculations, such as phasors (which may or may not be synchronized as synchrophasors), events, fault distances, differentials, impedances, reactances, frequency, and the like. IEDs 502-508 may also communicate settings information, IED identification information, communications information, status information, alarm information, and the like. Information of the types listed above, or more generally, information about the status of monitored equipment, may be generally referred to herein as monitored system data.

In certain embodiments, IEDs 502-508 may issue control instructions to the monitored equipment in order to control various aspects relating to the monitored equipment. For example, an IED (e.g., IED 506) may be in communication with a circuit breaker (e.g., breaker 556), and may be capable of sending an instruction to open and/or close the circuit breaker, thus connecting or disconnecting a portion of a power system. In another example, an IED may be in communication with a recloser and capable of controlling reclosing operations. In another example, an IED may be in communication with a voltage regulator and capable of instructing the voltage regulator to tap up and/or down. Information of the types listed above, or more generally, information or instructions directing an IED or other device to perform a certain action, may be generally referred to as control instructions.

The distributed site 550 may include an IED 508 for monitoring, controlling, and protecting the equipment of the distributed site 550 (e.g., generator 520, transformer 546, etc.). IED 508 may receive monitored system data, including current signals (e.g., current signals including overcurrent and/or interharmonic current information) via current transformer (CT) 558 and voltage signals via potential transformer (PT 560) from one or more locations (e.g., line 562) in the distribution site 550. The IED 508 may further be in communication with a breaker 564 coupled between the feeder 536 and the distribution site bus 552. In certain embodiments, the IED 508 may be configurable to cause the breaker 508 to disconnect the distribution site bus 552 from the distribution bus 536, based on monitored system data received via CT 558 and PT 560.

Feeder 540 may be communicatively coupled with an IED 506 configured to control a breaker 556 between the loads 544 and the distribution bus 536 based on monitored system data. In some embodiments, the power provided to the loads 544 from the distribution bus 536 may be stepped up or stepped down to an appropriate level via transformer 548. Like the IED 508 of the distribution site 550, monitored system data may be obtained by IED 506 using CTs and/or PTs (not shown).

Other IEDs (e.g., IED 504) may be configured to monitor, control, and/or protect the electric power generation and delivery system 500. For example IED 504 may provide transformer and generator protection to the step-up transformer 524 and generator 514. In some embodiments, IEDs 504-508 may be in communication with another IED 502, which may be a central controller, synchrophasor vector processor, automation controller, programmable logic controller (PLC), real-time automation controller, Supervisory Control and Data Acquisition (SCADA) system, or the like. For example, in some embodiments, IED 502 may be a synchrophasor vector processor. In other embodiments, IED 502 may be a real-time automation controller. IED 502 may also be a PLC or any similar device capable of receiving communications from other IEDs and processing the communications there from. In certain embodiments, IEDs 504-508 may communicate with IED 502 directly or via a communications network (e.g., network 566).

The central IED 502 may communicate with other IEDs 504-508 to provide control and monitoring of the other IEDs 504-508 and the power generation and delivery system 500 as a whole. In some embodiments, IEDs 504-508 may be configured to generate monitored system data in the form of time-synchronized phasors (synchrophasors) of monitored currents and/or voltages. In certain embodiments, synchrophasor measurements and communications may comply with the IEC C37.118 protocol. In certain embodiments, IEDs 502-508 may receive common time signals for synchronizing collected data (e.g., by applying time stamps for the like) and/or managing time-synchronized activities and/or communications. Accordingly, IEDs 502-508 may receive common time signals, such as an IRIG signal, from an accurate time reference 568 respectively. In some embodiments, the common time signals may be provided using a GPS satellite, a common radio signal such as WWV or WWVB, a network time signal such as IEEE 1588, or the like.

In certain embodiments, the common time signal provided by the accurate time reference 568 may provide an indication of an accurate and/or standardized time such as, for example, UTC or GMT, although other time standards may also be utilized in connection with the disclosed systems and methods. In further embodiments, common time signals may be provided to various IEDs by one or more synchronized distributed accurate time sources (not shown).

In some embodiments, common time signals may be provided directly to one or more IEDs 502-508 by time reference 568. For example, as illustrated, the accurate time reference 568 may provide a common time signal directly to IED 502. In certain embodiments, common time signals may be provided directly to receiving IEDs experiencing relatively minimal propagation delay in communication channel(s) between the accurate time reference 568 and/or the receiving IEDs. In further embodiments, one or more propagation delay correcting devices 510, 512 implementing embodiments of the systems and methods disclosed herein may be utilized to correct for propagation delay in common time signals occurring between the accurate time reference 568 and/or one or more receiving IEDs 504-508. For example, propagation delay correcting device 512 may correct for propagation delay in a common time signal during transmission from the accurate time reference 568 to IED 506. Similarly, propagation delay correcting device 510 may correct for propagation delay in a common time signal during transmission between the accurate time reference 568 to IEDs 504, 508. For example, in certain embodiments, based on respective amounts of estimated propagation delay between accurate time reference 568 and IEDs 504, 508, propagation delay correcting device 510 may correct for a first amount of propagation delay between reference 568 and IED 504 and a second amount of propagation delay between reference 568 and IED 508.

Several aspects of the embodiments described herein are illustrated as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (ASIC), PAL, PLA, PLD, field programmable gate array (FPGA), or any other customizable or programmable device.

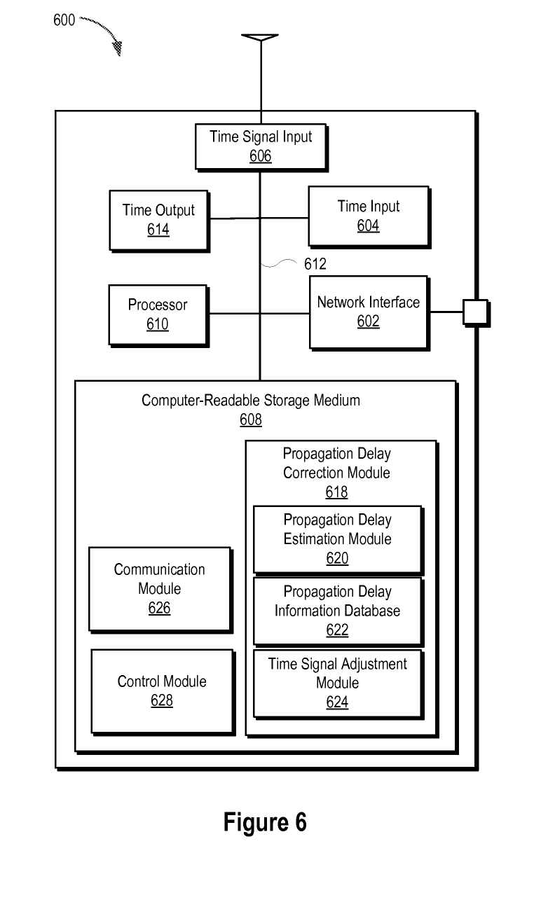

FIG. 6 illustrates a block diagram of an IED 600 consistent with embodiments disclosed herein. Embodiments of the IED 600 may be utilized to implement embodiments of the systems and methods disclosed herein. For example, the IED 600 may be configured to correct for propagation delay in time signals including, for example, IRIG encoded time signals.

IED 600 may include a network interface 602 configured to communicate with a communication network. IED 600 may also include a time input 604, which may be used to receive a common time signal. In certain embodiments, a common time reference may be received and/or transmitted via network interface 602, and accordingly, a separate time input 604 and/or Global Navigation Satellite System (GNSS) time input 606 may not be necessary. One such embodiment may employ the IEEE 1588 protocol. Alternatively, a GNSS input 606 may be provided in addition to, or instead of, time input 604. In certain embodiments, the time input 604 may provide a wired input time reference in the event a communication fail occurs with the GNSS time input 606. The IED 600 may further include a time output 614 for providing an output time signal corrected for associated propagation delay to one or more receiving IEDs and/or devices.

A computer-readable storage medium 608 may be the repository of one or more modules and/or executable instructions configured to implement any of the processes described herein. A data bus 612 may link time output 614, time input 604, network interface 602, GNSS time input 606, and the computer-readable storage medium 608 to a processor 610.

Processor 610 may be configured to process communications received via network interface 602, time input 604, GNSS time input 606, and/or information output by time output 614. Processor 610 may operate using any number of processing rates and architectures. Processor 610 may be configured to perform various algorithms and calculations described herein using computer executable instructions stored on computer-readable storage medium 608. Processor 610 may be embodied as a general purpose integrated circuit, an application specific integrated circuit, a field-programmable gate array, and/or other programmable logic devices.

Computer-readable storage medium 608 may be the repository of one or more modules and/or executable instructions configured to implement certain functions and/or methods described herein. For example, computer-readable storage medium 608 may include a propagation delay correction module 618, which may be a repository of the modules and/or executable instructions configured to implement the propagation delay correction functionalities described herein. The propagation delay correction module 618 may include, among other things, a propagation delay estimation module 620, a propagation delay information database 622, and a time signal adjustment module 624. The computer-readable medium 608 may further include a communication module 626 and a control module 628.

Propagation delay estimation module 620 may be configured to perform propagation delay estimation functions. In certain embodiments, the propagation delay estimation module 620 may estimate an amount of propagation delay between an accurate reference time source and one or more IEDs receiving a common time signal from the time source. In certain embodiments, the propagation delay estimation module 620 may estimate propagation delay based on available transmission parameters and information included in a propagation delay information database 622. The propagation delay information database 622 may, among other things, include information (e.g., a look-up table) associating propagation delay with various transmission parameters such as cable length, cable time, ambient temperature, and/or the like.

A time signal adjustment module 624 may be used to correct a common time signal received from the network interface 602, time input 604, and/or GNSS time input 606 for propagation delay and to generate a corrected common time signal for transmission via time output 614 based on the estimated propagation delay determined by the propagation delay estimation module 620. In certain embodiments, the common time signal adjustment module 620 may generate one or more corrected common time signals by advancing one or more reference indications included in a common time signal by period associated with the estimated propagation delay. For example, in an IRIG time signal where an on-time reference is associated with a rising signal edge of a second reference indication in a frame, the rising signal edge of the start-of-second reference may be advanced by the period associated with the estimated propagation delay in connection with generating a corrected IRIG time signal. In further embodiments, the common time signal adjustment module 620 may also advance signal edge transitions associated with encoded time information by the period associated with the estimated propagation delay.

A control module 628 may be configured for interacting with monitored equipment connected to distributed controller via a monitored equipment interface and/or via network interface 602. According to some embodiments, control instructions from the control module 628 may be intended as control instructions for other IEDs and/or monitored equipment located remote to IED 600. In some cases, control instructions may be only informative or suggestive, meaning that the receiving IED is not obligated to perform the control instruction. Rather, the receiving IED may use the suggested control instruction in coordination with its own determinations and information from other controllers to determine whether it will perform the control instruction. In other cases control instructions may be directive in that they are required actions. Differentiation between informative or suggestive control instructions and mandatory control instruction may be based on information included with the control instruction.

A communication module 626 may include instructions for facilitating communication of information from IED 600 to other controllers and/or other components in the electric power delivery system. The communication module 626 may include instructions on the formatting of communications according to a predetermined protocol. Communication module 626 may be configured with subscribers to certain information, and may format message headers according to such subscription information.

While specific embodiments and applications of the disclosure have been illustrated and described, it is to be understood that the disclosure is not limited to the precise configurations and components disclosed herein. For example, the systems and methods described herein may be applied to an industrial electric power delivery system or an electric power delivery system implemented in a boat or oil platform that may not include long-distance transmission of high-voltage power. In will further be appreciated that embodiments of the disclosed systems and methods may be utilized in connection with a variety of systems, devices, and/or applications utilizing time signals, including systems, devices, and/or applications that are not associated and/or otherwise included in an electric power delivery system. Accordingly, many changes may be made to the details of the above-described embodiments without departing from the underlying principles of this disclosure. The scope of the present invention should, therefore, be determined only by the following claims.

What is claimed is:

1. A device associated with an electric power delivery system, the device comprising:
an interface configured to receive a time signal from an accurate time source;
a processor communicatively coupled to the interface;
a computer-readable storage medium communicatively coupled to the processor, the computer-readable storage medium storing instructions that when executed by the processor cause the processor to:
determine a first estimated propagation delay between the accurate time source and a first receiving device,
generate a first corrected time signal by advancing a reference indication included in the time signal by the first estimated propagation delay, and
transmit the first corrected time signal to the first receiving device.

2. The device of claim 1, wherein the time signal comprises a inter-range instrumentation group encoded time signal.

3. The device of claim 1, wherein the reference indication comprises an indication denoting a start of a data frame of the time signal compromising encoded time information.

4. The device of claim 3, wherein the reference indication comprises an on-time reference rising signal edge indication.

5. The device of claim 4, wherein generation of the first corrected time signal further comprises advancement of a plurality of signal edges associated with encoded time information following the reference indication by the first estimated propagation delay.

6. The device of claim 1, wherein the time signal comprises a time signal generated using a reference atomic clock.

7. The device of claim 1, where determining the first estimated propagation delay between the accurate time source and the first receiving device is based on one or more transmission parameters associated with a communication channel between the accurate time source and the first receiving device.

8. The device of claim 7, wherein the one or more transmission parameters comprise one or more of a communication channel length, a communication channel type, and an ambient temperature.

9. The device of claim 7, wherein the one or more transmission parameters are provided to the device by user input.

10. The device of claim 1, wherein the instructions are further configured to cause the processor to:
determine a second estimated propagation delay between the accurate time source and a second receiving device;
generate a second corrected time signal by advancing a reference indication included in the time signal by the second estimated propagation delay; and
transmit the second corrected time signal to the second receiving device.

11. The device of claim 1, wherein the first estimated propagation delay comprises an estimated amount of propagation delay having previously occurred in the time signal prior to being received by the interface.

12. The device of claim 1, wherein the first estimated propagation delay comprises an estimated amount of anticipated propagation delay between the accurate time source and the first receiving device.

13. A method for generating a corrected time signal in an electric power delivery system comprising:
receiving a time signal from an accurate time source;
determining a first estimated propagation delay between the accurate time source and a first receiving device;
generating a first corrected time signal by advancing a reference indication included in the time signal by the first estimated propagation delay; and
transmitting the first corrected time signal to the first receiving device.

14. The method of claim 13, wherein the time signal comprises a inter-range instrumentation group encoded time signal.

15. The method of claim 13, wherein the reference indication comprises an indication denoting a start of a data frame of the time signal compromising encoded time information.

16. The method of claim 15, wherein the reference indication comprises an on-time reference rising signal edge indication.

17. The method of claim 16, wherein generating the first corrected common time signal further comprises advancing signal edges associated with encoded time information following the reference indication by the first estimated propagation delay.

18. The method of claim 13, wherein the common time signal comprises a time signal generated using a reference atomic clock.

19. The method of claim 13, where determining the first estimated propagation delay between the accurate time source and the first receiving device is based on one or more transmission parameters associated with a communication channel between the accurate time source and the first receiving device.

20. The method of claim 19, wherein the one or more transmission parameters comprise one or more of a communication channel length, a communication channel type, and an ambient temperature.

21. The method of claim 19, wherein the one or more transmission parameters are provided by user input.

22. The method of claim 13, wherein the method further comprises:
determining a second estimated propagation delay between the accurate time source and a second receiving device;
generating a second corrected common time signal by advancing a reference indication included in the common time signal by the second estimated propagation delay; and
transmitting the second corrected common time signal to the second receiving device.

23. The method of claim 13, wherein the first estimated propagation delay comprises an estimated amount of propagation delay having previously occurred in the time signal prior to being received from the accurate time source.

24. The device of claim 13, wherein the first estimated propagation delay comprises an estimated amount of anticipated propagation delay between the accurate time source and the first receiving device.

25. A device associated with an electric power delivery system, the device comprising:
an interface configured to receive an inter-range instrumentation group encoded time signal from an accurate time source;
a processor communicatively coupled to the interface;
a computer-readable storage medium communicatively coupled to the processor, the computer-readable storage medium storing instructions that when executed by the processor cause the processor to:
determine a first estimated propagation delay between the accurate time source and a first receiving device based on a length and a type of a communication channel between the accurate time source and the first receiving device,
generate a first corrected time signal by advancing an on-time reference indication included in the time signal by the first estimated propagation delay,
transmit the first corrected time signal to the first receiving device
determine a second estimated propagation delay between the accurate time source and a second receiving device;
generate a second corrected time signal by advancing a reference indication included in the time signal by the second estimated propagation delay; and
transmit the second corrected time signal to the second receiving device.
